(19) United States
(12) Patent Application Publication
(10) Pub. No.: US 2023/0321855 A1
(43) Pub. Date: Oct. 12, 2023

(54) KNIFE

(71) Applicant: Philip Morris Products S.A., Neuchâtel (CH)

(72) Inventors: Ivan CHIARINI, Bazzano (IT); Ivan PRESTIA, Calderara di Reno (IT)

(73) Assignee: Philip Morris Products S.A., Neuchâtel (CH)

(21) Appl. No.: 18/044,505

(22) PCT Filed: Sep. 8, 2021
(86) PCT No.: PCT/EP2021/074733

§ 371 Date: Mar. 8, 2023

(30) Foreign Application Priority Data
Sep. 16, 2020 (EP) 20196424.4

(51) Int. Cl. B26D 1/00; B26D 3/16; B26D 7/26; A24C 5/28

(52) U.S. Cl. CPC B26D 1/0006; B26D 3/166; B26D 7/2614; A24C 5/28; B26D 2001/006

(57) ABSTRACT

A knife is provided for a cutting device for cutting continuous rods in a manufacturing process, the knife including: a knife body having a distal end and a proximal end opposite the distal end, the knife body configured to be attached to a cutting device; and a cutting edge located at the distal end of the knife body, the cutting edge including at least two cutting edge segments, each cutting edge segment including a profile, the profile including one maximum protrusion from the knife body, and at least a portion of a second cutting edge segment of the at least two cutting edge segments protruding, from the knife body, to a greater extent than the maximum protrusion of a first cutting edge segment of the at least two cutting edge segments, from the knife body. A cutting device, and a method of manufacturing a cutting device, are also provided.

The present disclosure relates to a knife, and a cutting device comprising at least one knife, for cutting a continuous rod type product in a manufacturing process. The knife and the cutting device, may be part of a larger device, for example, a rod making machine. The present disclosure also relates to a method of using a cutting device, and a method of manufacturing a cutting device, for cutting a continuous rod type product in a manufacturing process.

Such knives and cutting devices are known in manufacturing processes to cut continuous rods, or strands, or filter components, or the like, to standard lengths completing many cuts per minute. These components are typically made by creating a long continuous rod of the desired diameter of the component, and then cutting to the required size. Such cutting devices may hold only one knife, but often comprise two knives, that are rotated. The rotation action ensures that the cutting edge of a knife contacts the product to be cut. The product to be cut is usually continuously moved along the cutting path.

The quality of the cutting is especially important as this affects the processes and operations downstream. For example, the quality of cutting is important for the operation of combining the component. A component which does not have a clean cut, or has a cut with low quality, is difficult to be properly combined with other components.

The present invention aims to improve cutting continuous rod products, and address or mitigate the limitation of known knives or cutting devices for cutting continuous rods in a manufacturing process. In particular, the present invention aims to provide a knife or cutting device, for cutting continuous rods in the manufacturing process, which can sustain a high frequency use while maintaining a high quality of cut and remove, or at least alleviate, the need to frequently re-sharpen the knife. The present invention also aims to improve the method of manufacturing or using cutting devices for cutting continuous rods in a manufacturing process. The present invention is defined in the appended claims.

According to an aspect of the present invention, there is provided a knife for a cutting device for cutting continuous rods in a manufacturing process, comprising:
a knife body having a distal end, and a proximal end opposite the distal end, the knife body is configured to be attached to a cutting device; and,
a cutting edge located at the distal end of the knife body, the cutting edge comprising at least two cutting edge segments, each cutting edge segment comprises a profile, wherein the profile comprises one maximum protrusion from the knife body, and wherein at least a portion of the second cutting edge segment protrudes, from the knife body, to a greater extent than the maximum protrusion of the first cutting edge segment, from the knife body.

Advantageously the present invention enables cutting edge segments of the cutting edge to successively come into contact with the component to be cut, which creates a progressive cutting of the component. Such a progressive cut not only decreases the wear of the knife and therefore increases its durability. A progressive cut also creates a cleaner cut. The progressive cutting of the component allows the component to be more easily cut in a single motion and requires less force to be exerted. Thus, components cut by the knife are provided with a high quality cut. These components can be supplied downstream to subsequent manufacturing processes. The knife will require less maintenance and replacement from the reduced wear. A reduction in replacement frequency of the knife may decrease the cost of manufacturing. A reduction in replacement frequency of the knife may decrease the downtime of manufacturing. Therefore, the knife according to the invention may increase the efficiency of production compared to existing knives. The provision of another cutting edge segment also increases the chance of contact with the component that is to be cut. Another advantage with the present invention is in the cutting of a flexible, deformable or displaceable component. The provision of at least two cutting edge segments allows the component to settle after an initial cut, before the next cutting edge segment comes into contact with the component, producing a cleaner cut. The provision of at least two cutting edge segments in this way may also allow cutting edge segments to cut from different distances or positions. The provision of at least two cutting edge segments also allows small components of varying density and rigidity to be cut. This is especially true when the rod comprises a metal susceptor strip, for example, within a less rigid substrate material. Continuous rods or similar components are conveyed at a speed of up to 500 meters per minute and are cut into components only a few centimeters (typically 60 millimeters to 150 millimeters) in length. The present invention enables the maintaining of a high quality cut, even when cutting is carried out at high frequencies. The present invention also reduces dulling of the knife, which removes the need to sharpen the profile of the cutting edge using grinding processes. This allows fire risks to be removed caused by sparking during the grinding operation.

In some embodiments, the cutting edge comprises a third cutting edge segment, comprising a profile, wherein the profile comprises one maximum protrusion from the knife body, and wherein at least a portion of the third cutting edge segment protrudes, from the knife body, to a greater extent than the maximum protrusion of the second cutting edge segment, from the knife body. The provision of a third cutting edge segment, in this way, further creates a more progressive cut through contact of the component to be cut and the cutting edge of the knife. The provision of yet another cutting edge segment in this way provides another cutting edge, which increases the chance of contact of the cutting edge with the component to be cut. The provision of a third cutting edge segment allows the component to settle after an initial cut and secondary cut, before the third cutting edge segment comes into contact with the component. This may produce cleaner cut compared to a cutting edge with two segments. Having three cutting edge segments also has the advantage that the varying angle of cutting is better maintained by the three progressive cuts of the three cutting edge segments.

In some embodiments, the profile of at least one cutting edge segment comprises a non-linear profile. By providing a non-linear profile in this way, the cutting motion is more gradual and progressive, whilst still being in the motion of a single cut. The non-linear profile of the cutting edge segment also prevents slipping of the knife.

In some embodiments, the first cutting edge segment comprises a convex curved profile.

In some embodiments, the second cutting edge segment comprises a convex curved profile.

In some embodiments, the third cutting edge segment comprises a convex curved profile.

The provision of a convex curved profile is advantageous because it increases the smoothness of the cut. The cutting edge may be provided with multiple cutting edge segments each having a convex curved profile. This increases the overall strength of the cutting edge. Providing multiple cutting edge segments each having a convex curved profile further increases the smoothness of cut.

In some embodiments, the circumference length of the second cutting edge segment is greater than the circumference length of the first cutting edge segment. This is particularly advantageous because the first cutting edge segment engages first with the component to be cut, and the component is then progressively cut more by the second cutting edge segment as the second cutting edge segment comes into contact with the component.

In some embodiments, the circumference length of the second cutting edge segment is less than the circumference length of the first segment.

In some embodiments, the circumference length of the second cutting edge segment is the same as the circumference length of the first cutting edge segment.

In some embodiments, the circumference length of the third cutting edge segment is greater than the circumference length of the second cutting edge segment. This is particularly advantageous because the second cutting edge segment engages with the component to be cut, and then the component is then progressively cut more by the third cutting edge segment as the third cutting edge segment comes into contact with the component.

In some embodiments, the circumference length of the third cutting edge segment is less than the circumference length of the second cutting edge segment.

In some embodiments, the circumference length of the third cutting edge segment is the same as the circumference length of the second cutting edge segment.

In some embodiments, the circumference length of the first, second and third cutting edge segments are equal in length.

The circumference length of a cutting edge segment may be, for example, between 5 millimetres and 200 millimetres, or between 5 millimetres and 50 millimetres, or between 5 millimetres and 25 millimetres, or between 4 millimetres and 16 millimetres.

In some embodiments the circumference length of the cutting edge segments may be equal in length. In alternative embodiments the circumference length of the cutting edge segments may be different in length.

In some embodiments the profile of the cutting edge segment is linear. In such embodiments comprising a cutting edge segment with a linear profile, the maximum protrusion, of the cutting edge segment may be a sharp point.

In alternative embodiments comprising a cutting edge segment comprising a non-linear profile. The maximum protrusion of the cutting edge segment may be a smooth curved peak.

In some embodiments comprising a cutting edge segment comprising a non-linear profile, the curved profile may be in the form of a portion of a circle. In some embodiments the profile of a cutting edge segment is in the form of a portion of a circle.

In particular embodiments comprising two or more cutting edge segments, one, some or all of the cutting edge segments may comprise a profile comprising part of a circle in shape. Advantageously where all cutting edge segments comprise a profile comprising part of a circle in shape, this may enable a smooth clean cut.

In preferred embodiments the first cutting edge segment comprises a profile with a maximum protrusion, from the knife body, that is less in amount than the maximum protrusion of the profile of the second, and subsequent, cutting edge segments.

In preferred embodiments each cutting edge segment comprises a profile with a maximum protrusion, from the knife body, that is less in amount than the maximum protrusion of the profile of subsequent cutting edge segments. The advantage of this is that a stepped increasing length of the cutting edge is produced. This also exposes a new cutting edge. Furthermore, there is provided a clean cut.

In some preferred embodiments the direction of cutting is that the cutting edge segment with a profile with the lowest maximum protrusion, from the knife body, is the first segment to cut then the second and subsequent cutting edge segments are able to cut as the knife rotates. Thus, the portion of the item to be cut, for example a rod, that is nearest to the central point of rotation of the knife, is cut first. Then portions of the item to be cut further from the central point of rotation of the knife, may in some embodiments, be cut slightly later. In some preferred embodiments the rotation of the knife is in the direction of the cutting edge segment comprising a profile with the lowest maximum protrusion form the knife body. The advantage of this is that each cutting edge segments may be exposed to the item for cutting, giving a stepped cut. This is particularly advantageous for cutting rods with components of varying rigidity, for example, if comprise a susceptor.

In a particular embodiment the knife comprises three cutting edge segments; the second cutting edge segment comprises a profile with a maximum protrusion, from the knife body, that is greater in amount than the maximum protrusion of the profile of the first cutting edge segment; the third cutting edge segment comprises a profile with a maximum protrusion, from the knife body, that is greater in amount than the maximum protrusion of the profile of the second cutting edge segment.

In some embodiments the cutting edge segment with the lowest maximum protrusion is the cutting edge segment positioned furthest to the left of the series of cutting edge segments. In some embodiments the cutting edge segment with the lowest maximum protrusion is the cutting edge segment positioned furthest to the right of the series of cutting edge segments.

In some embodiments the knife is moved in the direction of the cutting edge segment with the lowest maximum protrusion. Thus, the cutting edge segment with the lowest maximum protrusion may cut first.

According to another aspect of the present invention, there is provided a cutting device for cutting a continuous rod product in a manufacturing process, comprising:
a knife holder configured to mount at least one knife, the knife holder having an actuator operable to drive a cutting edge of the at least one knife towards a product to be cut.
a knife comprising:
   a knife body having a distal end, and a proximal end opposite the distal end, the knife body is configured to be attached to the knife holder; and,
   a cutting edge located at the distal end of the knife body, the cutting edge comprising at least two cutting edge segments, each cutting edge segment comprises a profile, wherein the profile comprises one maximum protrusion from the knife body, and wherein at least a portion of the second cutting edge segment protrudes, from the knife body, to a greater extent than the maximum protrusion of the first cutting edge segment, from the knife body.

According to a yet another aspect of the present invention, there is provided a method of using a cutting device for cutting a continuous rod product in a manufacture process, comprising the steps of:
providing a knife, wherein the knife comprises:
   a knife body having a distal end, and a proximal end opposite the distal end, the knife body is configured to be attached to a knife holder; and,
   a cutting edge located at the distal end of the knife body, the cutting edge comprising at least two cutting edge segments, each cutting edge segment comprises a profile, wherein the profile comprises one maximum protrusion from the knife body, and wherein at least a portion of the second cutting edge segment protrudes, from the knife body, to a greater extent than the maximum protrusion of the first cutting edge segment, from the knife body; and,
mounting at least one said knife to a knife holder, the knife holder comprising an actuator; and,
operating the actuator to drive the cutting surface of the knife towards a product to be cut.

According to some embodiments of the method of using a cutting device further comprises the step of: continuously rotating the knife towards a product to be cut. In some embodiments the method of using a cutting device comprises rotating the knife in the direction of the first cutting edge segment.

According to some embodiments of the method of using a cutting device, the method further comprises the step of: rotating two knives towards a product to be cut, the two knives mounted on the same knife holder. This has the advantage that the rotational speed does not need to be so fast to obtain more cuts, one rotation is able to obtain two cuts.

According to some embodiments of the method of using a cutting device, the method further comprises the step of: continuously conveying the product to be cut across the cutting path. This enable the product to be cut, for example rods, to be cut to length in a quick and efficient manner.

According to some embodiments, the continuous rod product comprises a susceptor. In some embodiments, the method of using a cutting device further comprises the step of cutting a susceptor. The knife of the present invention may enable the clean cutting of a continuous rod product comprising a susceptor.

According to a further aspect of the present invention, there is provided a method of manufacturing a cutting device for cutting a continuous rod product in a manufacturing process, comprising the steps of:
providing a knife, wherein the knife comprises:
   a knife body having a distal end, and a proximal end opposite the distal end, the knife body is configured to be attached to a knife holder; and
   a cutting edge located at the distal end of the knife body, the cutting edge comprising at least two cutting edge segments, each cutting edge segment comprises a profile, wherein the profile comprises one maximum protrusion from the knife body, and wherein at least a portion of the second cutting edge segment protrudes, from the knife body, to a greater extent than the maximum protrusion of the first cutting edge segment, from the knife body; and
mounting at least one said knife to a knife holder; and,
connecting an actuator to the knife holder such that the actuator is able to rotate the knife holder to drive the cutting edge of the knife towards a product to be cut.

In some embodiments, the circumference length of the third cutting edge segment is the same length as the circumference length of the first cutting edge segment.

In some embodiments, at least one cutting edge segment of the cutting edge comprises an asymmetric profile.

In some embodiments, at least one cutting edge segment of the cutting edge comprises a stepped profile.

In some embodiments, the cutting edge comprises ceramic. In some embodiments, the cutting edge segments comprise ceramic. In other embodiments, the knife comprises ceramic. In some embodiments the ceramic is a coating. In some embodiments the ceramic is a coating over the cutting edge of the knife. Having a knife, cutting edge or cutting edge segment comprising ceramic is beneficial because ceramic has good resistance to wear and dulling.

In alternative embodiments, the cutting edge comprises metal carbide. In some embodiments, the cutting edge segments comprise metal carbide. In other embodiments, the knife comprises metal carbide. In some embodiments the metal carbide is a coating. In some embodiments the metal carbide is a coating over the cutting edge of the knife. Having a knife, cutting edge or cutting edge segment comprising metal carbide is beneficial because metal carbide has good resistance to wear and dulling.

In other embodiments, the cutting edge comprises metal nitride. In some embodiments, the cutting edge segments comprise metal nitride. In other embodiments, the knife comprises metal nitride. In some embodiments the metal nitride is a coating. In some embodiments the metal nitride is a coating over the cutting edge of the knife. Having a knife, cutting edge or cutting edge segment comprising metal nitride is beneficial because metal nitride has good resistance to wear and dulling. As used herein, the term “actuator” is used to describe a device that is used to directly operate another device, or cause another device to operate. For example, the actuator of the knife holder operates to drive the knife towards the product to be cut.

As used herein, the term “asymmetrical profile” is used to describe a profile where the first half of the profile is not a mirror image of the second half of the profile.

As used herein, the term “circumference length” is used to describe the outer, or peripheral length or measurement of an item. Where a profile is a non-linear profile, the circumference length is used to describe the length along that profile.

As used herein, the term “curve” is used to describe a line or a profile that is not linear.

As used herein, the term “cutting edge” is used to describe the sharp surface that is used to perform the cutting, for example, dividing of a component into smaller elements.

As used herein, the term “cutting edge segment” is used to describe a part or a portion of the knife end comprising the cutting surface or cutting edge. It is used to describe a portion that has one maximum protrusion from the knife body. The cutting edge segment, having one maximum protrusion, will have a profile with a generally same direction, which may be a curve, and the cutting edge segment will end, and another cutting edge segment start when the profile takes a different direction. For example, in embodiments with three cutting edge segments, wherein each cutting edge segment is a convex curve, each cutting edge segment profile, moving from left to right, has a general direction of increasing in protrusion from the knife body, reaching a maximum protrusion from the knife body before decreasing in protrusion from the knife body. At the point of change of direction where the profile increases in protrusion from the knife body again this is the start of the next cutting edge segment. The same applies whether the profile of the cutting edge segment is convex, concave, linear or an asymmetrical curve, or any other suitable shape.

As used herein, the term “distal end” is used to describe the furthest end of an object. In particular when referring to the distal end of the knife it is used to describe the cutting end.

As used herein, the term “knife body” is used to describe the main structure of the knife.

As used herein, the term “maximum protrusion from the knife body” is used to describe a point at which the greatest displacement is provided relative to the knife body. For example, a maximum protrusion from the knife body describes a point that provides a greatest displacement or separation relative to the knife body. The term “from the knife body” indicates a separation that is determined as a shortest possible displacement from one element to another element, measured, for example, from a portion of the cutting edge segment that is closest to the knife body, to a portion of the knife body that is closest to the respective cutting edge segment.

As used herein, the term “profile” is used to describe the shape or outline of an element.

As used herein, the term “protrude” or “protrusion” is used to describe the displacement of an element or part of an element relative to a designated surface.

As used herein, the term “proximal end” is used to describe the near end of an object. In particular when referring to the proximal end of the knife it is used to describe the end furthest from the cutting end. The proximal end of the knife may be the end that attaches into the cutting device, or may have attachment mechanisms to assist in the mounting of the knife to the cutting device.

As used herein, the term “rod” is used to describe a substantially cylindrical element of substantially circular, oval or elliptical cross-section. The rod may include a number of different components. For example, the rod may include tobacco and a sheet of homogenized tobacco, preferably cast leaf tobacco. The rod may include a susceptor, positioned centrally within rod.

As used herein, the term “rotate” or “rotation” is used to describe the action of moving an object about a pivot. Often this movement will be circular. However, the movement of the object may be in a non-perfect circular motion. For example, the rotation may form an elliptical path or a path having a different trajectory. The advantage of a rotation of the knife that is not a perfect circle is that it may allow the knife to move, at or closer to the 90 degree angle from the object to be cut.

Any of the features or steps described herein in relation to one embodiment, aspect or example, of the knife or cutting device (including the apparatus) for manufacturing a knife or a cutting device, the method of manufacturing a knife or cutting device, or a part thereof of any knife or cutting device, or a method of using a knife or cutting device, may be equally applicable to any embodiment, aspect or example of the knife or cutting device (including the apparatus), the method of manufacturing a knife or cutting device, or the method of using a knife or cutting device.

The invention is as defined in the claims. However, below there is provided a non-exhaustive list of non-limiting examples. Any one or more of the features of these examples may be combined with any one or more features of another example, embodiment, or aspect described herein.

### EXAMPLES

Ex1. A knife for a cutting device for cutting continuous rods in a manufacturing process, comprising:
a knife body having a distal end, and a proximal end opposite the distal end, the knife body is configured to be attached to a cutting device; and,
a cutting edge located at the distal end of the knife body, the cutting edge comprising at least two cutting edge segments, each cutting edge segment comprises a profile, wherein the profile comprises one maximum protrusion from the knife body, and wherein at least a portion of the second cutting edge segment protrudes, from the knife body, to a greater extent than the maximum protrusion of the first cutting edge segment, from the knife body.
   Ex2. A knife according to example Ex1, wherein the cutting edge comprises a third cutting edge segment, comprising a profile, wherein the profile comprises one maximum protrusion from the knife body, and wherein at least a portion of the third cutting edge segment protrudes, from the knife body, to a greater extent than the maximum protrusion of the second cutting edge segment, from the knife body.
   Ex3. A knife according to example Ex1 or Ex2, wherein the profile of at least one cutting edge segment comprises a non-linear profile.
   Ex4. A knife according to any one of the preceding examples, wherein the first cutting edge segment comprises a convex curved profile.
   Ex5. A knife according to any one of the preceding examples, wherein the second cutting edge segment comprises a convex curved profile.
   Ex6. A knife according to any one of examples Ex2 to Ex5, wherein the third cutting edge segment comprises a convex curved profile.
   Ex7. A knife according to any preceding example, wherein the circumference length of the second cutting edge segment is greater than the circumference length of the first cutting edge segment.
   Ex8. A knife according to any one of examples Ex1 to Ex6, wherein the circumference length of the second cutting edge segment is less than the circumference length of the first segment.
   Ex9. A knife according to any one of examples Ex1 to Ex6, wherein the circumference length of the second cutting edge segment is the same as the circumference length of the first cutting edge segment.
   Ex10. A knife according to example Ex2 or Ex6, wherein the circumference length of the third cutting edge segment is greater than the circumference length of the second cutting edge segment.
   Ex11. A knife according to example Ex2 or Ex6, wherein the circumference length of the third cutting edge segment is less than the circumference length of the second cutting edge segment.
   Ex12. A knife according to example Ex2 or Ex6, wherein the circumference length of the third cutting edge segment is the same as the circumference length of the second cutting edge segment.
   Ex13. A knife according to example Ex2, Ex6 or Ex12, wherein the circumference length of the third cutting edge segment is the same length as the circumference length of the first cutting edge segment.
   Ex14. A knife according to any one of the preceding examples, wherein at least one cutting edge segment of the cutting edge comprises an asymmetric profile.
   Ex15. A knife according to any one of the preceding examples, wherein at least one cutting edge segment of the cutting edge comprises a stepped profile.
   Ex16. A knife according to any one of the preceding examples, wherein the cutting edge comprises ceramic.
   Ex17. A knife according to any one of the preceding examples, wherein the cutting edge comprises metal carbide.
   Ex18. A knife according to any one of the preceding examples, wherein the cutting edge comprises metal nitride.
   Ex19. A cutting device for cutting a continuous rod product in a manufacturing process, comprising:
a knife holder configured to mount at least one knife, the knife holder having an actuator operable to drive a cutting edge of the at least one knife towards a product to be cut.
a knife comprising:
   a knife body having a distal end, and a proximal end opposite the distal end, the knife body is configured to be attached to a knife holder; and,
   a cutting edge located at the distal end of the knife body, the cutting edge comprising at least two cutting edge segments, each cutting edge segment comprises a profile, wherein the profile comprises one maximum protrusion from the knife body, and wherein at least a portion of the second cutting edge segment protrudes, from the knife body, to a greater extent than the maximum protrusion of the first cutting edge segment, from the knife body.
      Ex20. A method of using a cutting device for cutting a continuous rod product in a manufacture process, comprising the steps of:
providing a knife, wherein the knife comprises:
   a knife body having a distal end, and a proximal end opposite the distal end, the knife body is configured to be attached to a knife holder; and,
   a cutting edge located at the distal end of the knife body, the cutting edge comprising at least two cutting edge segments, each cutting edge segment comprises a profile, wherein the profile comprises one maximum protrusion from the knife body, and wherein at least a portion of the second cutting edge segment protrudes, from the knife body, to a greater extent than the maximum protrusion of the first cutting edge segment, from the knife body; and,
mounting at least one said knife to a knife holder, the knife holder comprising an actuator; and,
operating the actuator to drive the cutting surface of the knife towards a product to be cut.
   Ex21. A method according to example Ex20, further comprising the step of: continuously rotating the knife towards a product to be cut.
   Ex22. A method according to example Ex20 or Ex21, further comprising the step of: rotating two knives towards a product to be cut, the two knives mounted on the same knife holder.
   Ex23. A method according to any one of examples Ex20 to Ex22, further comprising the step of: continuously conveying the product to be cut across the cutting path.
   Ex24. A method according to any one of examples Ex20 to Ex23, wherein the continuous rod product comprises a susceptor, and wherein the method further comprises the step of cutting the susceptor.
   Ex25. A method of manufacturing a cutting device for cutting a continuous rod product in a manufacturing process, comprising the steps of:
providing a knife, wherein the knife comprises:
   a knife body having a distal end, and a proximal end opposite the distal end, the knife body is configured to be attached to a knife holder; and,
   a cutting edge located at the distal end of the knife body, the cutting edge comprising at least two cutting edge segments, each cutting edge segment comprises a profile, wherein the profile comprises one maximum protrusion from the knife body, and wherein at least a portion of the second cutting edge segment protrudes, from the knife body, to a greater extent than the maximum protrusion of the first cutting edge segment, from the knife body; and,
mounting at least one said knife to a knife holder; and,
connecting an actuator to the knife holder that the actuator is able to rotate the knife holder to drive the cutting edge of the knife towards a product to be cut.

Reference will now be made to the drawings, which depict one or more embodiments described in this disclosure. However, it will be understood that other embodiments not depicted in the drawings fall within the scope of this disclosure. Like numbers used in the figures refer to like components, steps and the like. However, it will be understood that the use of a number to refer to a component in a given figure is not intended to limit the component in another figure labeled with the same number. In addition, the use of different numbers to refer to components in different figures is not intended to indicate that the different numbered components cannot be the same or similar to other numbered components. The figures are presented for purposes of illustration and not limitation. Schematic drawings presented in the figures are not necessarily to scale.

Examples will be further described with reference to the figures in which:

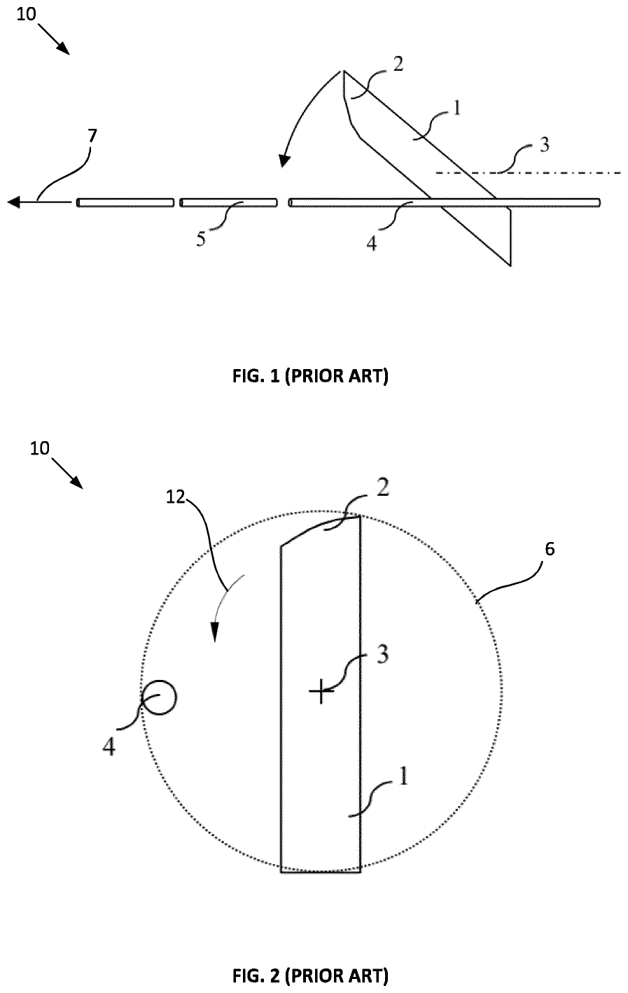

FIG. 1 is a cutting device of the prior art;

FIG. 2 is a cutting device of the prior art;

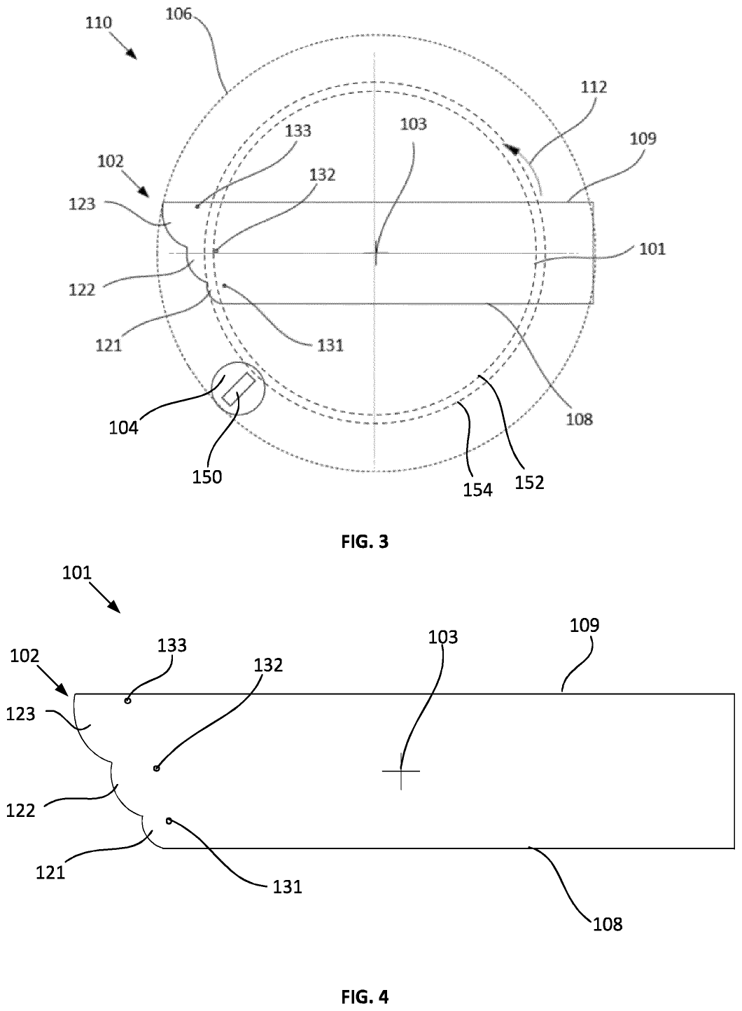

FIG. 3 is a schematic illustration of a cutting device according to embodiment of the present invention;

FIG. 4 is a schematic illustration of a knife according to an embodiment of the present invention;

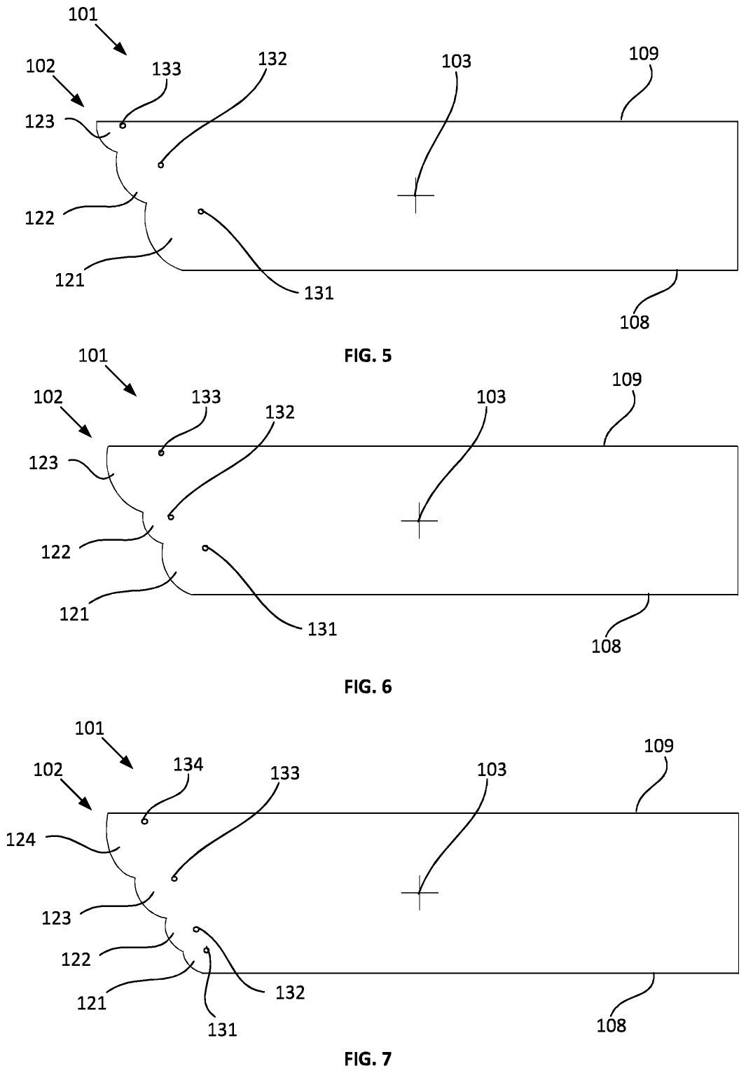

FIG. 5 is a schematic illustration of a knife according to another embodiment of the present invention;

FIG. 6 is a schematic illustration of a knife according to a further embodiment of the present invention; and

FIG. 7 is a schematic illustration of a knife according to another embodiment of the present invention.

FIG. 1 and FIG. 2 show an example of a cutting device 10 of the prior art. The cutting device 10 has a generally flat rectangular knife 1, connected at its center 3 to a shaft that rotates about a rotational axis 3. A continuous rod 4 is moved along a conveyor in a direction denoted by the arrow 7. The end of the knife 1 has a sharp cutting edge 2 which crosses the path of the continuous rod 4 to be cut as the knife 1 is rotated by the shaft, which cuts the continuous rod 4 is cut into smaller parts 5. Referring to FIG. 2, the cutting edge 2 of the knife 1 moves in a circular path 6, in a direction denoted by the arrow 12. The continuous rod 4 is placed in the path 6 of the knife 1, and is cut.

In FIGS. 3 and 4, there is shown a knife 101 and a cutting device 110 that includes the knife 101 mounted to a knife holder. In this example, the knife 101 is mounted by its center 103. The knife holder is provided with an actuator (not shown) that is used to drive and rotate the knife about its center 103, in a direction denoted by the arrow 112. The knife 101 includes a knife body having a distal end and a proximal end opposite the distal end. The knife 101 has a first lateral side 108 and a second lateral side 109 provided on a side opposite the first lateral side 108. A cutting edge generally denoted 102 is located on the distal end of the knife 101. The cutting edge 102 forms the blade of the knife 101, used to cut a continuous rod product. In this particular example illustrated, when the knife 101 is rotated about its center 103 by the actuator, the cutting edge 102 of the knife 101 moves in a circular path, denoted 106. In other examples, the cutting edge 102 of the knife 101 may move in a path that is not circular. For example, the path 106 may be elliptical. A continuous rod 104 is aligned on the cutting path 106 of the knife 101 in order to be cut by the cutting edge 102 of the knife 101 during use. The continuous rod 104 in this example is a tobacco rod having a homogenised web of tobacco, with a metal susceptor 150 embedded within the tobacco. However, other rods 104 are also envisaged such as a polylactic acid filter tow, a mouthpiece filter or a hollow acetate tube, for example.

When the cutting device 110 is driven, the cutting edge 102 of the knife 101, in this example, is driven to move in a circular path 106. The cutting edge 102 is aligned with the rod 104 to be cut, which in this case is a tobacco rod 104. At the same time, the rod 104 is moved along a conveying path. By synchronising the rotation of the knife 101 with the speed at which the rod 104 moves, the rod 104 is cut by the knife 101 to a predetermined length. In this example, the rod 104 is conveyed at a speed of 300 meters per minute, and is cut to a component length of 80 millimeters. The precision of cutting of the rod 104 is of particular importance when the cutting device 101 operates at high speeds, which is achieved by the design of the knife 101, as will now be described.

The cutting edge 102 of the knife 101 is provided with a first cutting edge segment 121, a second cutting edge segment 122, and a third cutting edge segment 123. The cutting edge segments 121,122,123 are spaced along the cutting edge 102. The first cutting edge segment 121 is located on the first lateral side 108 of the knife 101. The third cutting edge segment 123 is located on the second lateral side 122 of the knife 101 The second cutting edge segment 122 is located between the first cutting edge segment 121 and the third cutting edge segment 123. Though in this example, three cutting edge segments 121,122,123 are shown, it is envisaged that the cutting edge 102 may be provided with two cutting edge segments or more than three cutting edge segments such as for example, four, five, or six cutting edge segments. Each of the cutting edge segments 121, 122, 123 has a profile. The profile of each cutting edge segment 121,122,123 is a non-linear profile. In this example, the profile is a convex curved profile. Other profiles are also envisaged, such as a stepped profile, an asymmetric profile, an asymmetric curved profile, or a profile having a non-constant curvature.

Each cutting edge segment 121, 122, 123 is provided with a maximum protrusion from the knife body. That is, each cutting edge segment 121, 122, 123 has a point (that is, at least a portion) at which the profile protrudes a maximum distance from the body of the knife 101. The first cutting edge segment 121 has a maximum protrusion, from the knife body. The second cutting edge segment 122 has a maximum protrusion, from the knife body, that is greater than the maximum protrusion of the first cutting edge segment 121. The third cutting edge segment 123 has a maximum protrusion, from the knife body, that is greater than the maximum protrusion of the second cutting edge segment 122. More specifically, in this example, the maximum protrusion of the first cutting edge segment 121, from the knife body, is 20 mm. The maximum protrusion of the second cutting edge segment 122, from the knife body, is 30 mm. The maximum protrusion of the third cutting edge segment 123, from the knife body, is 40 mm. The displacement between the central pivot 103 and the maximum protrusion point of the first cutting edge segment 121 is 120 mm. The displacement between the central pivot 103 and the maximum protrusion point of the second cutting edge segment 122 is 130 mm. The displacement between the central pivot 103 and the maximum protrusion point of the third cutting edge segment 123 is 140 mm.

The profile of each cutting edge segment 121, 122, 123 has a different circumference length in this example. The circumference length describes a length measurement of the curved profile. The circumference length describes the curvature of the cutting edge segment profile, about the respective center. In some example embodiments, the circumference length may refer to the length of the curved profile along its profile. The circumference length of the first cutting edge segment 121 is 30 millimetres, about the center 131, in this example, but it is envisaged that the circumference length may be in the range of 16 millimetres and 50 millimetres. The second cutting edge segment 122 has a circumference length that is greater than the circumference length of the first cutting edge segment 121. The circumference length of the second cutting edge segment 122 is 70 millimetres, about the center 132, in this example, but it is envisaged that the circumference length may be in the range of 50 millimetres and 100 millimetres. The third cutting edge segment 123 has a circumference length that is greater than the circumference length of the second cutting edge segment 122. The circumference length of the third cutting edge segment 123 is 130 millimetres, about the center 133, in this example, but it is envisaged that the circumference length may be in the range of 100 millimetres and 200 millimetres. When the knife 101 is in use, the cutting edge 102 which includes the first cutting edge segment 121, the second cutting edge segment 122, and the third cutting edge segment 123 contacts the product or article to be cut. In this example, the product to be cut is a continuous rod.

During cutting, the first cutting edge segment 121 of the cutting edge 102 comes into contact with the rod 104 to make an initial incision into the rod 104. As shown in FIG. 3, the first cutting edge segment 121 has a minimum protrusion point which moves in the path denoted 152, and a maximum protrusion point which moves in the path denoted 154. In this example embodiment, as the cutting edge 102 comes into contact with the rod 104, the minimum protrusion point on the first cutting edge segment 121 does not contact the rod 104. The maximum protrusion point of the first cutting edge segment 121 comes into contact with the rod 104. It can be seen that the first cutting edge segment 121 in this example is able to cut the rod 104, but not the susceptor 150 within the rod 104. As the knife 101 is moved further towards the rod 104, the second cutting edge segment 122 comes into contact with the rod 104 to further cut the rod 104. As the rod 104 comes into contact with and along the cutting edge 102 of the knife 101, the rod 104 is cut progressively. It can be seen that since the second cutting edge segment 122 protrudes to a greater extent that the first cutting edge segment 121, the second cutting edge segment 122 is capable of cutting the susceptor 150. In this particular embodiment, since the susceptor 150 is made from a relatively hard material in comparison to the tobacco, the susceptor 150 is displaced within the tobacco. As the knife 101 is moved further towards the rod 104, the third cutting edge segment 123 comes into contact with the rod 104, to cut it. The circumference length of the cutting edge segments 121, 122, 123 increase in the direction opposite the moving direction of the knife. The part of the cutting edge 102 with the smallest circumference length (the first cutting edge segment 121) is the first to contact the rod to be cut, followed by the subsequent (that is, second and then third) cutting edge segments 122, 123. The progressive cutting of the rod 104 in this way reduces wear of the cutting edge 102 of the knife 101. Also, cutting the rod 104 progressively like this requires less force to cut the rod 104 and the rod 104 has a greater chance of being cut by at least one of the cutting edge segments 121, 122, 123.

In some examples, the cutting edge 102 of the knife 101, or any surface of the knife 101 that is subject to wear, may be coated in a harder material to further reduce wear. For example, the cutting edge 102 may be coated in a ceramic material. In other examples, the knife 101 may be coated in a metal carbide or a metal nitride coating, for example. In some examples, the profile of the cutting edge segments 121, 122, 123 have a non-linear profile such as an asymmetric profile, an asymmetric curved profile, or a profile with a non-constant curve, for example. In one example, the profile of the cutting edge segments 121, 122, 123 has a stepped profile. The provision of a stepped profile provides a sharp change in the displacement between the contact point for the rod, and the central pivot of the knife 101, leading to a smooth cut.

FIG. 5 shows another example of a knife 101 having substantially the same features as the knife of FIG. 4, having a cutting edge 102 with a different design. The cutting edge 102 of the knife 101 is provided with a first cutting edge segment 121, a second cutting edge segment 122, and a third cutting edge segment 123. The cutting edge segments 121, 122, 123 have a convex curved profile. The first cutting edge segment 121 has a maximum protrusion, from the knife body. The second cutting edge segment 122 has a maximum protrusion, from the knife body, that is greater than the maximum protrusion of the first cutting edge segment 121. The third cutting edge segment 123 has a maximum protrusion, from the knife body, that is greater than the maximum protrusion of the second cutting edge segment 122.

In this example, the circumference length of the first cutting edge segment 121 is 150 mm, about the center 131, but it is envisaged that the circumference length may be in the range of 100 millimetres and 200 millimetres. The second cutting edge segment 122 has a circumference length that is greater than the circumference length of the first cutting edge segment 121. The circumference length of the second cutting edge segment 122 is 80 millimetres, about the center 132, in this example, but it is envisaged that the circumference length may be in the range of 50 millimetres and 100 millimetres. The third cutting edge segment 123 has a circumference length that is greater than the circumference length of the second cutting edge segment 122. The circumference length of the third cutting edge segment 123 is 25 millimetres, about the center 133, in this example, but it is envisaged that the circumference length may be in the range of 16 millimetres and 50 millimetres.

During cutting, the first cutting edge segment 121 of the cutting edge 102 comes into contact with the rod first to cut the rod. As the knife 101 is moved further towards the rod 104, the second cutting edge segment 122 comes into contact with the rod 104 to further cut the rod 104. As the knife 101 is moved further towards the rod 104, the third cutting edge segment 123 comes into contact with the rod 104, to cut it. The circumference length of the cutting edge segments 121, 122, 123 decrease in the direction opposite the moving direction of the knife. The part of the cutting edge 102 with the largest circumference length (the first cutting edge segment 121) is the first to contact the rod to be cut, followed by the subsequent (that is, second and then third) cutting edge segments 122, 123. This arrangement is particularly beneficial where the product to be cut is made of a flexible material. After the first cutting edge segment 121 contacts the rod, the rod may deform. As such, it is beneficial for the second cutting edge segment 122 (subsequent cutting edge segments) to have a circumference length that is smaller than the preceding segment(s), allowing the rod to contact the cutting edge further away.

FIG. 6 shows another example of a knife 101. The knife has substantially the same features as the aforementioned knives. However, the cutting edge is provided with a first cutting edge segment 121 having a circumference length that is greater than the circumference length of the second cutting edge segment 122, but less than the circumference length of the third cutting edge segment 123. In this example, the circumference length of the first cutting edge segment 121 is 90 millimetres, about the center 131, but it is envisaged that the circumference length may be in the range of 50 millimetres and 100 millimetres. The circumference length of the second cutting edge segment 122 is 35 millimetres, about the center 132, but it is envisaged that the circumference length may be in the range of 16 millimetres to 50 millimetres. The circumference length of the third cutting edge segment 123 is 110 millimetres, about the center 133, but it is envisaged that the circumference length may be in the range of 100 millimetres and 200 millimetres. During cutting, the first cutting edge segment 121 of the cutting edge 102 comes into contact with the rod first to cut the rod. As the knife 101 is moved further towards the rod 104, the second cutting edge segment 122 comes into contact with the rod 104 to further cut the rod 104. As the knife 101 is moved further towards the rod 104, the third cutting edge segment 123 comes into contact with the rod 104, to cut it.

FIG. 7 shows another example of a knife 101. The knife 101 is substantially the same as the knife in FIG. 4, but the cutting edge 102 of the knife 101 is provided with four cutting edge segments. The cutting edge 102 of the knife 101 is provided with a first cutting edge segment 121, a second cutting edge segment 122, a third cutting edge segment 123, and a fourth cutting edge segment 124, spaced along the cutting edge 102. The first cutting edge segment 121 is located on the first lateral side 108 of the knife 101. The fourth cutting edge segment 124 is located on the second lateral side 109 of the knife 101 The second cutting edge segment 122 and the third cutting edge segment 123 are located between the first cutting edge segment 121 and the fourth cutting edge segment 124. The profile of each cutting edge segment 121, 122, 123, 124 is a non-linear profile. In this example, the profile is a convex curved profile.

Each cutting edge segment 121, 122, 123, 124 is provided with a maximum protrusion from the knife body. The first cutting edge segment 121 has a maximum protrusion, from the knife body. The second cutting edge segment 122 has a maximum protrusion, from the knife body, that is greater than the maximum protrusion of the first cutting edge segment 121. The third cutting edge segment 123 has a maximum protrusion, from the knife body, that is greater than the maximum protrusion of the second cutting edge segment 122. The fourth cutting edge segment 124 has a maximum protrusion, from the knife body, that is greater than the maximum protrusion of the third cutting edge segment 123.

The profile of each cutting edge segment 121, 122, 123, 124 has a different circumference length. The circumference length of the first cutting edge segment 121 is 25 millimetres, about the center 131, in this example, but it is envisaged that the circumference length may be in the range of 10 millimetres and 40 millimetres. The second cutting edge segment 122 has a circumference length that is greater than the circumference length of the first cutting edge segment 121. The circumference length of the second cutting edge segment 122 is 60 millimetres, about the center 132, in this example, but it is envisaged that the circumference length may be in the range of 40 millimetres and 80 millimetres. The third cutting edge segment 123 has a circumference length that is greater than the circumference length of the second cutting edge segment 122. The circumference length of the third cutting edge segment 123 is 100 millimetres, about the center 133, in this example, but it is envisaged that the circumference length may be in the range of 80 millimetres and 120 millimetres. The circumference length of the fourth cutting edge segment 124 is 140 millimetres, about the center 134, in this example, but it is envisaged that the circumference length may be in the range of 120 millimetres to 160 millimetres.

When the first cutting edge segment 121 of the cutting edge 102 comes into contact with the rod to be cut, an incision is made onto the rod. As the knife 101 is moved further towards the rod 104, the second cutting edge segment 122 comes into contact with the rod 104 to further cut the rod 104. As the rod 104 comes into contact with and along the cutting edge 102 of the knife 101, the rod 104 is cut progressively. As the knife 101 is moved further towards the rod 104, the third cutting edge segment 123 comes into contact with the rod 104, to cut it. When the knife 101 is moved still further towards the rod 104, the fourth cutting edge segment 124 comes into contact with the rod 104, to cut it. The circumference length of the cutting edge segments 121, 122, 123, 124 increase in the direction opposite the moving direction of the knife. The part of the cutting edge 102 with the smallest circumference length (the first cutting edge segment 121) is the first to contact the rod to be cut, followed by the subsequent (that is, second and then third and then fourth) cutting edge segments 122, 123, 124. The progressive cutting of the rod 104 in this way reduces wear of the cutting edge 102 of the knife 101.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A plus or minus 5 percent of A. Within this context, a number A may be considered to include numerical values that are within general standard error for the measurement of the property that the number A modifies. The number A, in some instances as used in the appended claims, may deviate by the percentage enumerated above provided that the amount by which A deviates does not materially affect the basic and novel characteristic(s) of the claimed invention.

All scientific and technical terms used herein have meanings commonly used in the art unless otherwise specified. The definitions provided herein are to facilitate understanding of certain terms used frequently herein.

As used in this specification and the appended claims, the singular forms “a”, “an”, and “the” encompass embodiments having plural referents, unless the content clearly dictates otherwise.

As used in this specification and the appended claims, the term “or” is generally employed in its sense including, alternatively or in addition, unless the content clearly dictates otherwise.

As used herein, “have”, “having”, “include”, “including”, “comprise”, “comprising” or the like are used in their open-ended sense, and generally mean “including, but not limited to”. It will be understood that “consisting essentially of”, “consisting of”, and the like are subsumed in “comprising,” and the like.

The words “preferred” and “preferably” refer to embodiments of the invention that may afford certain benefits under certain circumstances. However, other embodiments may also be preferred under the same or other circumstances. Furthermore, the recitation of one or more preferred embodiments does not imply that other embodiments are not useful, and, is not intended to exclude other embodiments from the scope of the disclosure, including the claims.

Any direction referred to herein, such as “top,” “bottom,” “left,” “right,” “upper,” “lower,” and other directions or orientations, including numbering like first, second and third, are described herein for clarity and brevity are not intended to be limiting of an actual device or system. Devices and systems described herein may be used in a number of directions and orientations.

The embodiments exemplified above are not limiting. Other embodiments consistent with the embodiments described above will be apparent to those skilled in the art.

1.-15. (canceled)

16. A knife for a cutting device for cutting continuous rods in a manufacturing process, the knife comprising:
a knife body having a distal end and a proximal end opposite the distal end, the knife body being configured to be attached to a cutting device; and
a cutting edge located at the distal end of the knife body, the cutting edge comprising at least two cutting edge segments, each cutting edge segment comprising a profile,
wherein the profile comprises one maximum protrusion from the knife body, and
wherein at least a portion of a second cutting edge segment of the at least two cutting edge segments protrudes, from the knife body, to a greater extent than the maximum protrusion of a first cutting edge segment of the at least two cutting edge segments, from the knife body.

17. The knife according to claim 16,
wherein the cutting edge further comprises a third cutting edge segment, comprising a profile,
wherein the profile of the third cutting edge segment comprises one maximum protrusion from the knife body, and
wherein at least a portion of the third cutting edge segment protrudes, from the knife body, to a greater extent than the maximum protrusion of the second cutting edge segment, from the knife body.

18. The knife according to claim 16, wherein the profile of at least one cutting edge segment of the at least two cutting edge segments comprises a non-linear profile.

19. The knife according to claim 16, wherein the first cutting edge segment comprises a convex curved profile.

20. The knife according to claim 16, wherein the second cutting edge segment comprises a convex curved profile.

21. The knife according to claim 17, wherein the third cutting edge segment comprises a convex curved profile.

22. The knife according to claim 16, wherein a circumference length of the second cutting edge segment is greater than a circumference length of the first cutting edge segment.

23. The knife according to claim 16, wherein a circumference length of the second cutting edge segment is less than a circumference length of the first segment.

24. The knife according to claim 16, wherein a circumference length of the second cutting edge segment is the same as a circumference length of the first cutting edge segment.

25. The knife according to claim 17, wherein a circumference length of the third cutting edge segment is greater than a circumference length of the second cutting edge segment.

26. The knife according to claim 17, wherein a circumference length of the third cutting edge segment is less than a circumference length of the second cutting edge segment.

27. The knife according to claim 17, wherein a circumference length of the third cutting edge segment is the same as a circumference length of the second cutting edge segment.

28. A cutting device for cutting a continuous rod product in a manufacturing process, the cutting device comprising:
a knife holder configured to mount at least one knife, the knife holder having an actuator configured to drive a cutting edge of the at least one knife towards a product to be cut; and
a knife comprising:
a knife body having a distal end and a proximal end opposite the distal end, the knife body being configured to be attached to a knife holder, and
a cutting edge located at the distal end of the knife body, the cutting edge comprising at least two cutting edge segments, each cutting edge segment comprising a profile, wherein the profile comprises one maximum protrusion from the knife body, and wherein at least a portion of a second cutting edge segment of the at least two cutting edge segments protrudes, from the knife body, to a greater extent than the maximum protrusion of a first cutting edge segment of the at least two cutting edge segments, from the knife body.

29. A method of operating a cutting device for cutting a continuous rod product in a manufacture process, the method comprising the steps of:
providing a knife, wherein the knife comprises:
a knife body having a distal end and a proximal end opposite the distal end, the knife body being configured to be attached to a knife holder, and
a cutting edge located at the distal end of the knife body, the cutting edge comprising at least two cutting edge segments, each cutting edge segment comprising a profile, wherein the profile comprises one maximum protrusion from the knife body, and wherein at least a portion of a second cutting edge segment of the at least two cutting edge segments protrudes, from the knife body, to a greater extent than the maximum protrusion of a first cutting edge segment of the at least two cutting edge segments, from the knife body;
mounting the knife to a knife holder, the knife holder comprising an actuator; and
operating the actuator to drive a cutting surface of the knife towards a product to be cut.

30. A method of manufacturing a cutting device for cutting a continuous rod product in a manufacturing process, the method comprising the steps of:
providing a knife, wherein the knife comprises:
a knife body having a distal end and a proximal end opposite the distal end, the knife body being configured to be attached to a knife holder, and
a cutting edge located at the distal end of the knife body, the cutting edge comprising at least two cutting edge segments, each cutting edge segment comprising a profile, wherein the profile comprises one maximum protrusion from the knife body, and wherein at least a portion of a second cutting edge segment of the at least two cutting edge segments protrudes, from the knife body, to a greater extent than the maximum protrusion of a first cutting edge segment of the at least two cutting edge segments, from the knife body;
mounting the knife to a knife holder; and
connecting an actuator to the knife holder such that the actuator is configured to rotate the knife holder to drive a cutting edge of the knife towards a product to be cut.
